(19) United States
(12) Patent Application Publication
(10) Pub. No.: US 2007/0226716 A1
(43) Pub. Date: Sep. 27, 2007

(54) SOFTWARE SYSTEM ARCHITECTURE AND APPLICATION PROGRAM PROCESSING METHOD

(75) Inventor: Ming-Hsien Chen, Taoyuan (TW)

Correspondence Address: ISHIMARU & ZAHRT LLP, 333 W. EL CAMINO REAL, SUITE 330, SUNNYVALE, CA, 94087, US

(73) Assignee: MITAC INTERNATIONAL CORPORATION, Taoyuan (TW)

(21) Appl. No.: 11/533,678

(22) Filed: Sep. 20, 2006

(30) Foreign Application Priority Data
Feb. 14, 2006 (TW) 095104864

(51) Int. Cl. G06F 9/45

(52) U.S. Cl. 717/148

(57) ABSTRACT

A software system architecture and an application program processing method is disclosed involving placing application programs on an application program layer, using a compiler program provided on a compiler program layer to compile the application programs to generate compiled code, using a process program provided on a process layer to generate hardware control signals to control a hardware unit provided on the hardware layer in accordance with the compiled code, so as to enable the hardware unit to execute corresponding processes. By such a system and method, the software system architecture is simplified and the system operation efficiency of an electronic device adopting the software system architecture is greatly improved. Specifically, through the use of the present invention, Java application programs are executed without directly using the operating system of a platform, thus improving the operating efficiency of a system adopting the system architecture and providing more system stability.

### BACKGROUND OF THE INVENTION

1. Field of the Invention

This invention relates to software system architectures and application program processing methods, and more particularly, to a software system architecture and an application program processing method is applicable in an electronic device having a process platform for executing Java application programs and a hardware unit corresponding to the process platform.

2. Description of Related Art

A Java application program is an object-orientated programming language that can be applied to various software or hardware platforms. Such cross-platform functionality is realized by use of a so-called Java virtual machine (JVM), which acts as a kind of translator between Java applications and an underlying software system architecture running Java applications such that Java applications can be run on various software systems without modification for a particular system, any required modifications being made automatically by the Java virtual machine preinstalled on the software systems running such Java applications.

The software system architecture of a general data processing device configured to run Java programs such as a personal computer (PC) hierarchically comprises (from top to bottom) a Java application program layer, a JVM layer, an operation system (OS) layer, a basic input output system (BIOS) layer, and a hardware layer. A Java application program installed in a PC is not directly executed by the central processing unit (CPU) of the PC. The CPU cannot execute a Java application program unless the Java instructions of such a Java application program have been read and compiled by the JVM of the PC into codes that are transferred to and utilized by the OS layer of the PC. In other words, a Java application program cannot communicate with the OS layer of the PC without the JVM.

Herein, a Java application program refers to Java bytecode corresponding to a high-level, English-like Java program, such code being produced when a Java compiler initially compiles a Java program into Java bytecode. At or prior to runtime, this initial compilation is succeeded by a secondary compilation by the Java virtual machine (using either on-the-fly interpretation or just-in-time compilation), wherein the bytecode of a Java application program is compiled into native code that can be used by the specific system that will run the program. Therefore, in the following, compilation by the Java virtual machine refers to this secondary compilation of the bytecode into specific instructions for the system running the program, as opposed to the one-time initial compilation of a high-level program into bytecode.

However, in that the JVM can neither communicate with the BIOS of the PC (because the languages that the JVM and BIOS utilize are different from each other) nor control system operations of the PC, such as task processing, memory management, file resources, and hardware input/output signals, the JVM, when executing a Java application program, has to resort to assistance from the operating system OS (for example Linux or Windows) or software platform (for example Browser or VxWorks) to manage task processing, memory management, file resources, and hardware input/output signals. Under such an architecture, the JVM therefore executes the Java application program inefficiently.

In other words, because the JVM concentrates on managing the compilation of Java application programs, and a modern data processing device comprises various I/O hardware components, such as a hard disk drives (HDD), a universal serial bus (USB), and a display controller/adapter, the OS has to be in charge of the control processes for software programs and hardware units located in the bottom layers (for example the hardware layer). In short, the OS executes the system architecture for Java application programs in the existing Java system architecture. However, in addition to the execution of Java application programs, the OS has to further manage a variety of other system operations, such as those mentioned previously. Therefore, this further limits the operating efficiency of the current software system architecture in executing Java application programs on the data processing device employing such architecture.

Moreover, as electronic information technology has developed rapidly in recent years, a conventional BIOS program cannot satisfy the demands of modern information products. Accordingly, in order to satisfy the demands, an extensible firmware interface (EFI) has been introduced to the market to replace the conventional BIOS program of a computer system. Although still in charge of the demodulation functions for various hardware components, the EFI, unlike the BIOS program, is not impeded by as many technical restrictions as are imposed on the BIOS program. Secondly, although the BIOS program is written in low-level assembly language, the EFI is written in high-level C language (or similar). Also, the EFI cannot only support old system programs, but is also applicable to embedded application programs. Moreover, program developers can, through the use of standard program developing tools, provide the EFI with a variety of additional functionality, such as diagnostic functions or self-configuring programs. However, a drawback for EFI systems is that the EFI cannot work unless it is utilized in conjunction with an OS program.

Therefore, a critical need exists in the art for a system that can take advantage of the extensible characteristics of the EFI and provide a more simplified software system architecture, to improve system operation efficiency of a data process device.

### SUMMARY OF THE INVENTION

In view of the above-mentioned problems of the prior art, it is a primary objective of the present invention to provide a software system architecture and an application program processing method that can simplify the system architecture of Java software programs and improve the operating efficiency of the system.

It is another objective of the present invention to provide a software system architecture and an application program processing method that can improve system stability.

To achieve the above-mentioned and other objectives, a software system architecture is provided according to the present invention. The software system architecture is applicable in an electronic device having a process platform for executing an application program and a hardware unit corresponding to the process platform. The software system architecture includes an application program layer for placement of application programs; a compiler layer for placement of compiled programs corresponding to the application programs, wherein a compiler program compiles the application programs and generates compiled code; a process layer for placement of a process program, wherein the process program generates corresponding hardware control signals in accordance with the compiled code; and a hardware layer configured with a hardware unit for enabling the hardware unit to be controlled so as to execute corresponding processes in accordance with the hardware control signals generated by the process program.

According to the preferred embodiment, the application program is a Java application program, the compiler program is the Java virtual machine (JVM), and the process program is an extensible firmware interface (EFI). Moreover, the process program generates in accordance with the compiler code corresponding I/O hardware control signals, which are used for enabling the electronic device to execute on the process platform the processes corresponding to the controlled hardware unit. The electronic device is embedded with an operating system or an embedded system.

Further, an application program processing method is further provided and applied to the software system architecture. The application program processing method includes placing application programs on the application program layer; installing a compiler program to create a compiler layer, and using the compiler program to compile the application programs of the application layer to generate corresponding compiled code; installing a process program to create a process layer, and using the process program to generate hardware control signals in accordance with the compiled code for the compiled application programs; and establishing the hardware unit on the hardware layer, and enabling the hardware unit to be controlled to execute corresponding processes in accordance with the hardware control signals.

According to the preferred embodiment, the application program is a Java application program, the compiler program is the JVM, and the process program is an EFI. Moreover, the process program generates in accordance with the compiler code corresponding I/O hardware control signals that are used for enabling the electronic device to execute on the process platform control processes corresponding to the hardware unit. Generally, the electronic device is provided with an operating system, either loaded or embedded, or some kind of embedded control system; however, it is conceivable that these might be eliminated if the process program were further developed to provide any other needed services.

Compared with the prior art, the software system architecture and application program processing method can not only simplify the system architecture of a system, but also improve the stability and operating efficiency of a system.

### BRIEF DESCRIPTION OF DRAWINGS

The invention can be more fully understood by reading the following detailed description of the preferred embodiments, with reference made to the accompanying drawings, wherein:

FIG. 1 is a schematic diagram of a software system architecture of the preferred embodiment according to the present invention; and

FIG. 2 is a flow chart of an application program processing method corresponding to the software system architecture shown in FIG. 1.

### DETAILED DESCRIPTION OF PREFERRED EMBODIMENTS

The following illustrative embodiments are provided to illustrate the disclosure of the present invention, these and other advantages and effects being readily understandable by those in the art after reading the disclosure of this specification. The present invention can also be performed or applied by other differing embodiments. The details of the specification may be changed on the basis of different points and applications, and numerous modifications and variations can be devised without departing from the spirit of the present invention.

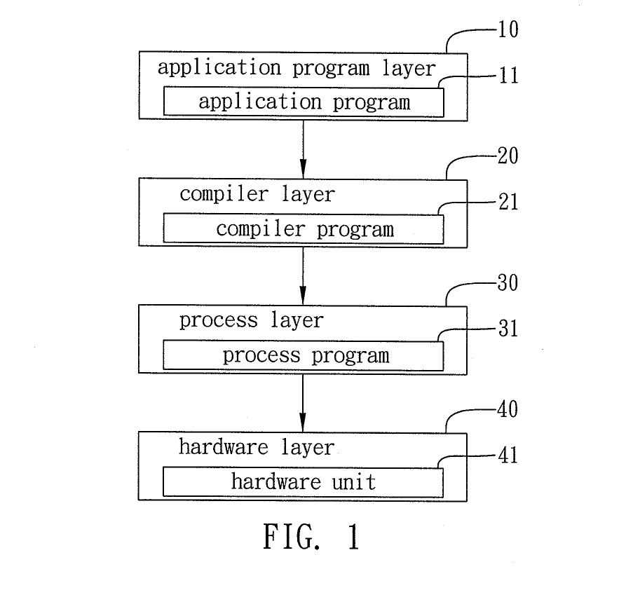

FIG. 1 depicts a schematic diagram of a software system architecture of the preferred embodiment according to the present invention. The software architecture is applicable in an electronic device (not shown) having a process platform (not shown) for executing Java application programs and a hardware unit 41 utilized by the process platform.

As shown in FIG. 1, the software system architecture comprises an application program layer 10, a compiler layer 20, a process layer 30, and a hardware layer 40, all of which will be described in detail in the following paragraphs.

The application program layer 10 is used for placement of application programs 11. According to the preferred embodiment, the application programs 11 are Java application programs.

The compiler layer 20 comprises a compiler program 21, which is a JVM system that is utilized in conjunction with application programs 11. Accordingly, after a Java application program is placed on the application program layer 10, the JVM system compiles the Java application program to generate compiled code. In actual implementation, the JVM system typically generates separate JVM runtime instances for each Java application program being executed. The compiler program 21 is a known technique in the art, therefore further description is omitted.

The process layer 30 is used for placement of a process program 31 corresponding to the compiler program 21. According to the preferred embodiment, the process program 31 is an EFI that generates corresponding hardware control signals such as I/O hardware control signals in accordance with the compiled code generated by the compiler layer 20.

The hardware layer 40 is provided with a hardware unit 41 for enabling the hardware unit 41 to be controlled to execute corresponding processes in accordance with the I/O hardware control signals generated by the process program 31.

From the above, it can be seen that the software system architecture comprises only four layers to execute Java application programs, bypassing dependence on the OS layer and BIOS layer that are necessary in the architecture of a personal computer system, or the embedded OS layer and boot loader layer that are necessary for an embedded system. In other words, by installing the process layer 30 (for example, the EFI) between the compiler layer 20 (for example, a JVM system) and the hardware layer 40, the present invention can execute Java application programs. As such, the process layer 30 manages execution of Java application programs, easing the burden on the operating system and improving system operating efficiency of the electronic device.

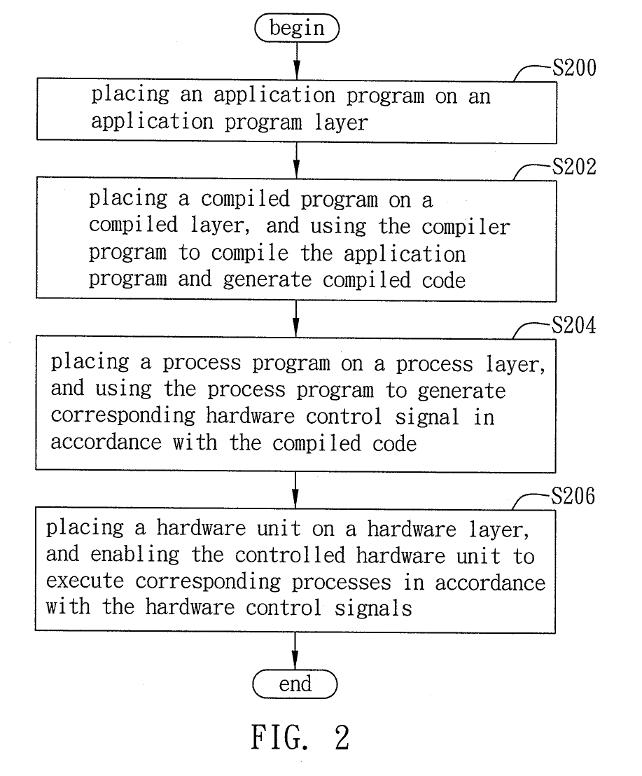

FIG. 2 depicts a flow chart of an application program processing method corresponding to the software system architecture shown in FIG. 1. As shown in FIG. 2, the method begins in step S200. In step S200, the method places application programs 11 on the application program layer 10. Application programs 11 refer to Java application programs (comprised of Java bytecode). Then, the method proceeds to step S202.

In step S202, the method compiles the application programs 11 using the compiler program 21 of the compiler layer 20 to produce compiled programs corresponding to the application programs 11. In this example, the compiler program 21 is a Java Virtual Machine (JVM) system together with the individual JVM runtime instances for each Java application program being executed, and the application programs 11 are Java application programs. Then, the method proceeds to step S204.

In step S204, the method utilizes the process program 31 provided on the process layer 30 to issue commands that correspond to the compiled programs 21. According to the preferred embodiment, the process program 31 is an EFI, which generates corresponding hardware control signals, i.e. I/O hardware control signals, in accordance with the compiled code generated by the compiler layer 20. Then, the method proceeds to step S206.

In step S206, the method utilizes the hardware unit 41 of the electronic device provided on the hardware layer 40 to enable the hardware unit 41 to be controlled to execute corresponding processes in accordance with the I/O hardware control signals generated by the EFI placed on the process layer 30.

In the foregoing, the placements are performed automatically and refer to creating representative data structures and instructions, such as program code in various forms, in memory areas used to implement the conceptual architectural levels. The division of system software into various architectural levels is common place and will not be further detailed.

In summary, the software system architecture and application program processing method first places application programs on an application program layer; then, a compiler program provided on a compiler program layer is used to compile the application program to generate compiled code; next, a process program provided on a process layer is used to generate corresponding hardware control signals to control a hardware unit provided on the hardware layer in accordance with the compiled code, so as to enable the hardware unit to execute corresponding processes. Therefore, the software system architecture is simplified and the system operating efficiency of an electronic device adopting the software system architecture is greatly improved. In short, through the use of the present invention, Java application programs are not executed by an OS operating platform, but more directly by the hardware. Consequently, the operating efficiency of a system adopting the architecture of the invention is improved and the system is more stable.

The foregoing descriptions of the detailed embodiments are only illustrated to disclose the features and functions of the present invention and are not restrictive of the scope of the present invention. It should be understood by those in the art that various modifications and variations can be made according to the spirit and principles in the disclosure of the present invention and yet still fall within the scope of the invention as defined in the appended claims.

What is claimed is:

1. A software system architecture applicable in an electronic device having a process platform for executing application programs and a hardware unit corresponding to the process platform, the software system architecture comprising:
an application program layer for placement of application programs;
a compiler layer with a compiler program for placement of compiled programs corresponding to the application programs, wherein the compiler program compiles the application programs and generates compiled code;
a process layer provided with a process program, wherein the process program generates corresponding hardware control signals in accordance with the compiled code; and
a hardware layer utilizing the hardware unit, wherein the hardware unit can be controlled to execute corresponding processes in accordance with the hardware control signals.

2. The software system architecture of claim 1, wherein the application programs are Java application programs.

3. The software system architecture of claim 1, wherein the compiler program is a Java virtual machine (JVM) producing runtime instances of Java applications.

4. The software system architecture of claim 1, wherein the process program is an extensible firmware interface (EFI).

5. The software system architecture of claim 1, wherein the process program generates in accordance with the compiled code corresponding I/O hardware control signals that are used to enable the electronic device to execute on the process platform processes corresponding to the hardware unit.

6. An application program processing method comprising:
providing an application program layer and placing application programs on the application program layer;
providing a compiler layer and placing on the compiler layer compiled programs that correspond to the application programs, wherein the compiler program compiles the application programs to generate compiled code;
providing a process layer and placing on the process layer a process program, and utilizing the process program to generate in accordance with the compiled code corresponding hardware control signals; and
providing a hardware layer that utilizes a hardware unit, and enabling the hardware unit to execute corresponding processes in accordance with the hardware control signals generated by the process program of the process layer.

7. The application program processing method of claim 6, wherein the application programs are Java application programs.

8. The application program processing method of claim 6, wherein the compiler program is a Java virtual machine (JVM) producing runtime instances of Java applications.

9. The application program processing method of claim 6, wherein the process program is an extensible firmware interface (EFI).

10. The application program processing method of claim 6, wherein the process program generates in accordance with the compiled code corresponding I/O hardware control signals that are used to enable the electronic device to execute on the process platform processes corresponding to the hardware unit.
